(19) United States
(12) Patent Application Publication
(10) Pub. No.: US 2001/0003811 A1
(43) Pub. Date: Jun. 14, 2001

(54) Method and system for rendering a view such as an arrangement for creating a lighting pattern

(76) Inventors: Rufus W. Warren, Oak Lawn, IL (US); John E. Gorman, Woodridge, IL (US); Joseph DiPaula, Hedgesville, WV (US)

Correspondence Address: Roger J. French, Esq., Jenkens & Gilchrist, P.C., Suite 3200, 1445 Ross Avenue, Dallas, TX, 75202-2799, US

(21) Appl. No.: 09/727,054

(22) Filed: Nov. 30, 2000

Related U.S. Application Data
(63) Continuation-in-part of application No. 09/159,382, filed on Sep. 23, 1998, now abandoned.

(51) Int. Cl. G06F 17/50

(52) U.S. Cl. 703/1

(57) ABSTRACT

A method for reducing the barriers between creative designs and complete drawings and databases by generating complex engineering drawings, such as lighting systems from lines and/or other simple shapes automatically, eliminates the tedious, time-consuming tasks of drawing, placing and annotating elements of structure, such as mounting trusses, fixtures, lighting patterns (often referred to as “gobos”), projectors and any other lighting, sound, video, plumbing, HVAC, street layouts or other graphical representations.

### CROSS-REFERENCE TO RELATED APPLICATION

This is a continuation-in-part of U.S. patent application Ser. No. 09/159,382, filed Sep. 23, 1999 and entitled “Method and System for Rendering a View of an Arrangement for Creating a Lighting Pattern.”

### BACKGROUND OF THE INVENTION

Until recently, lighting designs, like many other types of designs, were drawn by hand on drafting tables. Producers and directors tried to bring their artistic visions to reality with artists' conceptions of the ultimate results of set design and lighting. The availability of photo-realistic renderings of lighting scenes has raised expectations of drawings for planning and presentations.

The details of lighting fixture placement, lamp and filter selection to achieve the desired results have always been dependent on the experience and judgment of the lighting director and staff. With the advent of computer assistance for placing lighting instruments, it became possible to design larger and more elaborate lighting systems in reasonable amounts of time. This provides more options for, but also imposes a larger burden on, designers who need to provide ever more accurate and realistic drawings.

The increased time it takes design these larger systems offsets much of the time gained through using computers to place instruments, draw plots and render images, even with drafting software which includes libraries of available fixtures, trusses, speakers, etc. The need to provide more choices, accuracy and faster response to clients makes the need for assistance with the mundane details of large systems ever more critical.

### OBJECTS AND SUMMARY OF THE INVENTION

Briefly, in accordance with the foregoing, a method for modeling the utilization of substantially all of an emitted beam of a lamp in a lighting fixture by a gobo which is not necessarily the same diameter as a barrel of the fixture comprises computing a placement of a point source of light inside said lighting fixture to yield a specified beam angle, and computing a placement of said gobo in front of said lighting fixture so the diameter of said gobo matches the diameter of said emitted beam emerging from said fixture.

In accordance with another embodiment of the invention, a method for modeling a lighting system employs a computing system having graphic a display, and said method comprises entering and storing lighting fixture data into said computing system, entering and storing fixture support data into said computing system, entering and storing guide data into said computing system, said guide data including the types and locations of fixture supports and lighting fixtures, computing from said guide data a two or three dimensional representation of said lighting system, and displaying said representation on said graphic display.

In accordance with another embodiment of the invention, a method for automatically constructing a relatively complex representation of an object based on a relatively simple representation of an object comprises generating a relatively simple representation of an object, and building a link between said relatively simple representation and a relatively complex representation of an object stored in a library.

In accordance with another embodiment of the invention, a system for modeling the utilization of substantially all of an emitted beam of a lamp in a lighting fixture by a gobo which is not necessarily the same diameter as a barrel of the fixture, comprises means for computing a placement of a point source of light inside said lighting fixture to yield a specified beam angle, and means for computing a placement of said gobo in front of said lighting fixture so the diameter of said gobo matches the diameter of said emitted beam emerging from said fixture.

In accordance with another embodiment of the invention a system for modeling a lighting system employing a computing system having graphic a display comprises means for entering and storing lighting fixture data into said computing system, means for entering and storing fixture support data into said computing system, means for entering and storing guide data into said computing system, said guide data including the types and locations of fixture supports and lighting fixtures, means for computing from said guide data a two or three dimensional representation of said lighting system, and means for displaying said representation on said graphic display.

In accordance with another embodiment of the invention a system for automatically constructing a relatively complex representation of an object based on a relatively simple representation of an object, comprises means for generating a relatively simple representation of an object, and means for building a link between said relatively simple representation and a relatively complex representation of an object stored in a library.

### BRIEF DESCRIPTION OF THE DRAWINGS

In the drawings:

FIG. 1 is an overall view of lighting fixture, gobo and resulting lighting effect preview;

FIG. 2 are various gobos and lighting fixtures;

FIG. 3 is a side view of lighting fixture and instrument vertical angle;

FIG. 4 is a side view of lighting fixture and gobo;

FIG. 5 is a side view of lighting fixture, lamp and filament;

FIG. 6 is a side view of lamp and gobo placement with controlled-angle light source;

FIG. 7 is an overhead view of lighting fixture and instrument horizontal angle;

FIG. 8 is an overhead view of lighting fixture and filament;

FIG. 9 is an overhead view of lighting fixture and gobo;

FIG. 10 is a dialog box of information on a lighting fixture with lamp;

FIG. 11 is an overhead view of section of lighting plot;

FIG. 12 is a flowchart of distance and angle calculations;

FIGS. 13A and 13B show lighting system outline;

FIG. 14 shows a lighting system outline in somewhat more detail;

FIG. 15 is a flowchart of automatic build procedure;

FIG. 16 shows an automatic build procedure of single-line object;

FIGS. 17A, 17B and 17C show an automatic build procedure of multiple-line object;

FIG. 18 is an overhead view of stage area with lighting system;

FIG. 19 shows an auto-build options dialog box;

FIG. 20 is a view of improved section;

FIG. 21 is an overhead view of stage area with improved lighting system;

FIG. 22 is an orthogonal view of stage area with lighting system;

FIG. 23 shows one construction of virtual guide-line;

FIG. 24 illustrates changing the size of an auto-built section based on changing a guide-object; and

FIG. 25 is an expressbuild options dialog box.

### DETAILED DESCRIPTION OF THE ILLUSTRATED EMBODIMENT

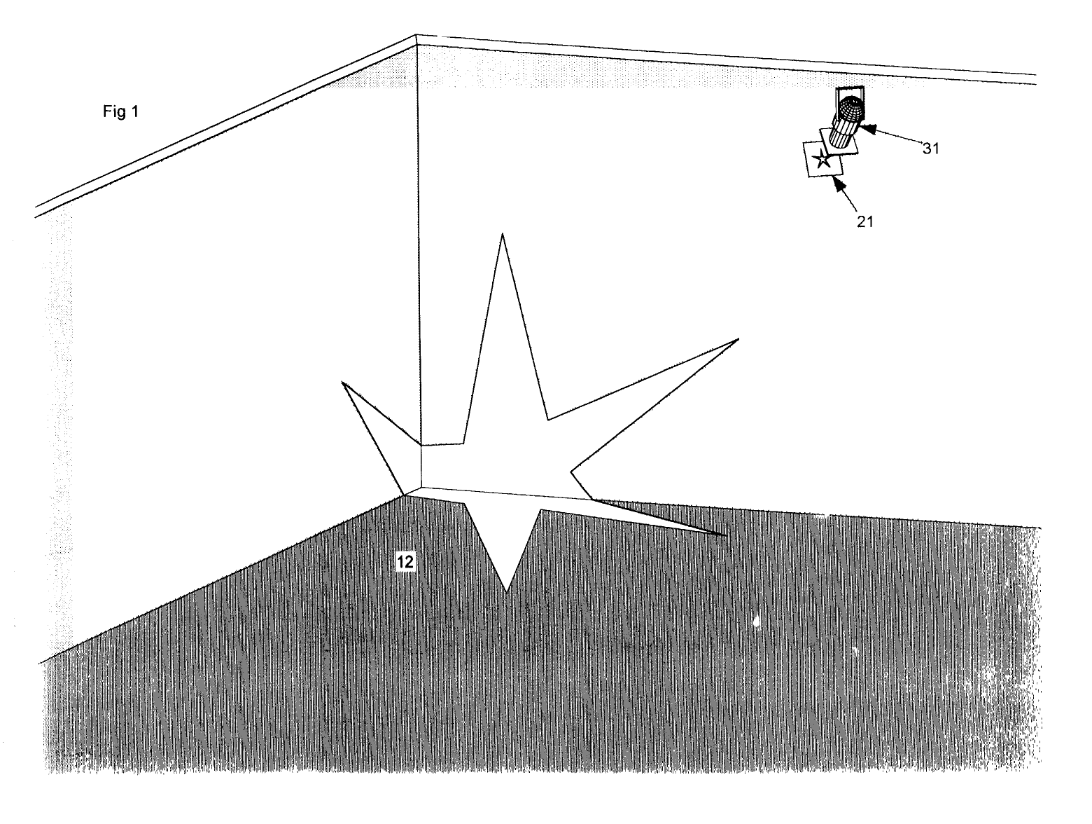

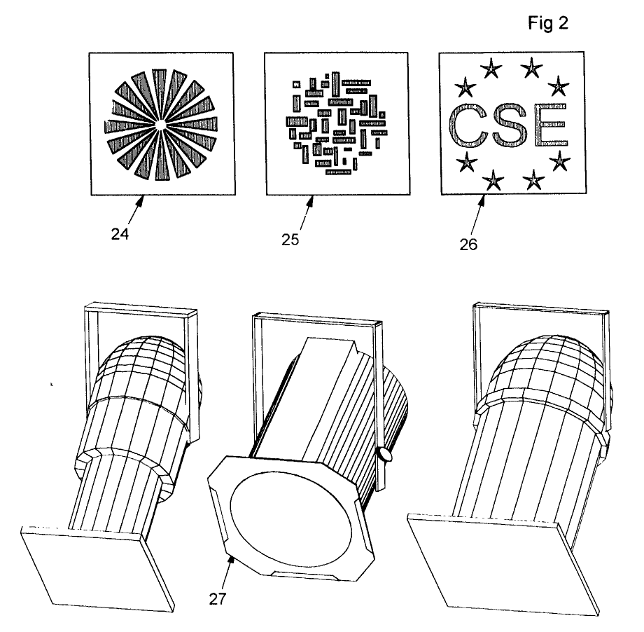

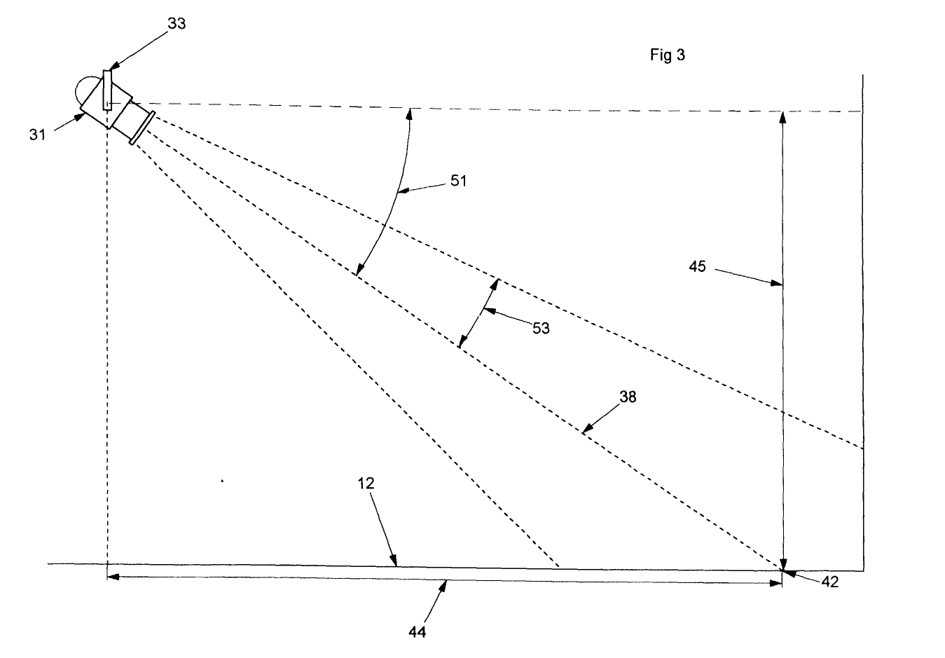

Referring now to the drawings, and initially to FIG. 1, FIG. 1 shows a basic combination of a fixture 31, gobo 21 and stage 12. The light from the lamp in the fixture travels through the gobo and strikes the various faces of the stage floor and walls, resulting in a quite non-intuitive pattern 15. As you can imagine, other gobo patterns 24, 25, 26, such as shown in FIG. 2, would be even more difficult to predict, especially on complicated targets. Gobos are most often rectangular or square so they can quickly be placed in a similarly shaped holder 27 on a fixture in the proper orientation.

In order that the projected pattern of the gobo is the desired size and strikes the desired target, (Refer to FIG. 3) the fixture 31, lamp 32 and gobo 21 must be placed properly relative to each other and the focus spot 42. This placement is performed through a series of calculations of distances and angles. CAD drawings, which may be viewed on the computer monitor or printed, are two-dimensional representations of objects in a database which contains information about the objects such as the location of the object's reference point in the 3-D drawing, the orientation of the object relative to its reference point, and other items such as color, line thickness, surface texture, etc. When an object is drawn manually, or a collection of objects which are treated as a single object (sometimes referred to as a block or a symbol) is placed manually, the person doing the drawing may use any convenient place on the object as a reference point. This might be the object center, or a corner or face. With automatic object placement, a reference point is chosen for each object, and this reference point must be located by calculating angles and distances between the reference point and the important physical features of the object. For example, most lighting instruments are hung from horizontal bars by a yoke attached to the fixture near its center of gravity. For convenience in relating the calculations to the underlying CAD drawing, a point 41 on the fixture 31 corresponding to its mounting yoke 33 axis of rotation is used as the origin (the zero point for horizontal and vertical distances). Also for convenience, the lamp is considered a point source, although the filament 34 occupies a finite space. Many pieces of information about each fixture, such as its length, diameter, weight, etc. can be stored in a database related to the fixture.

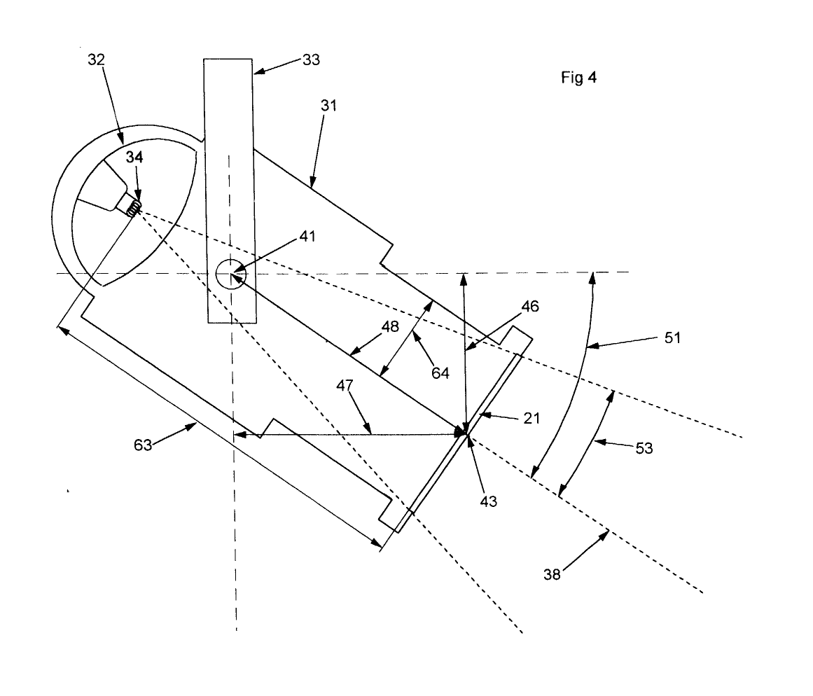

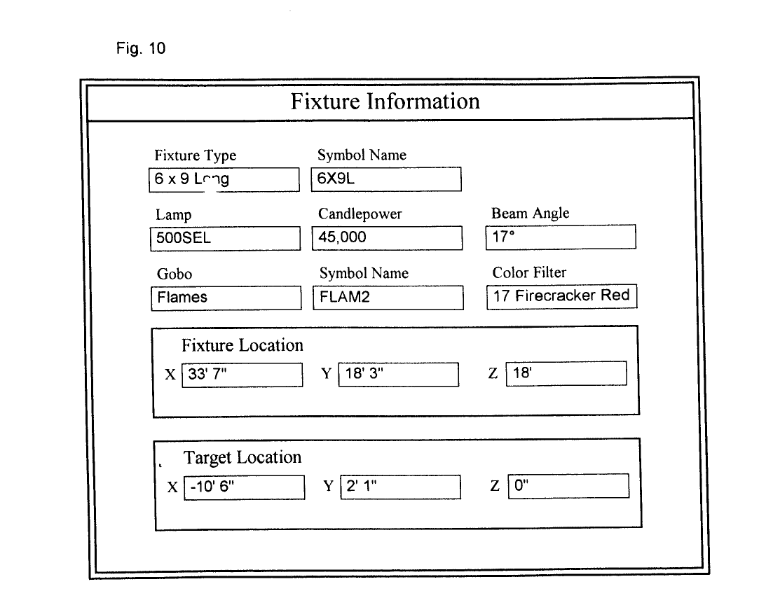

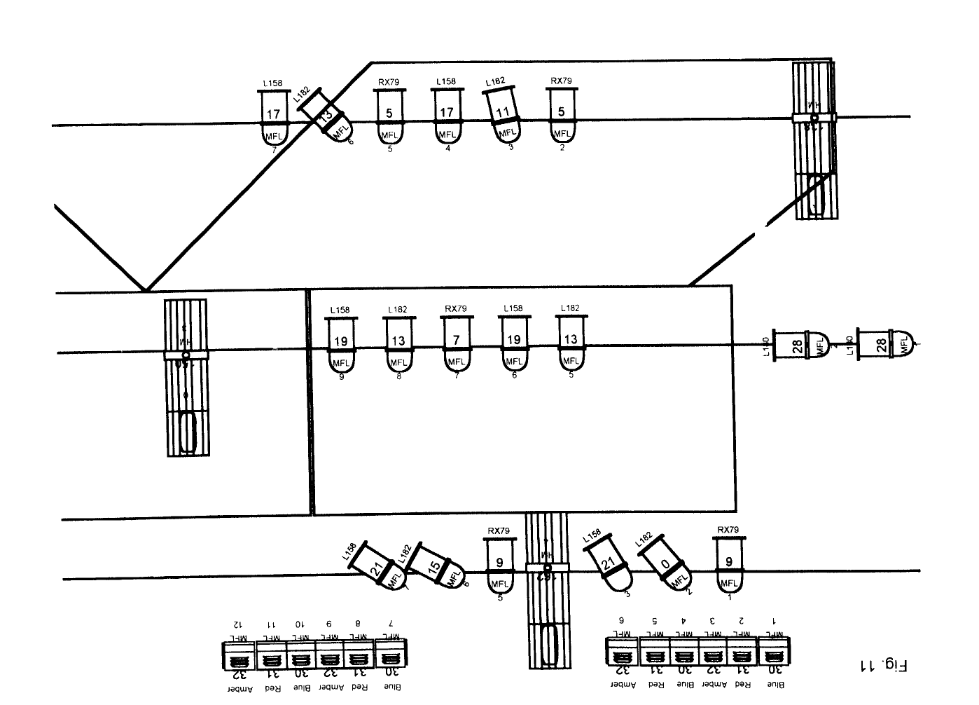

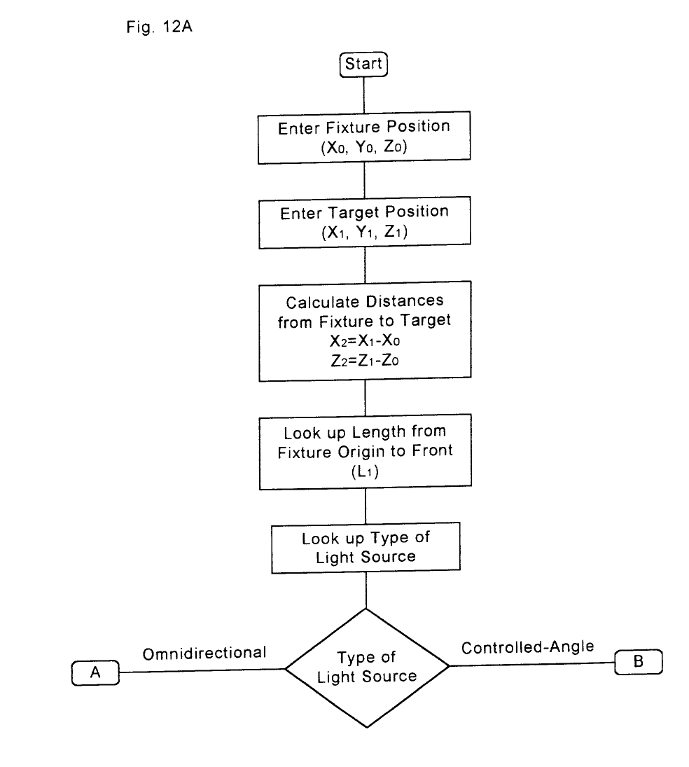

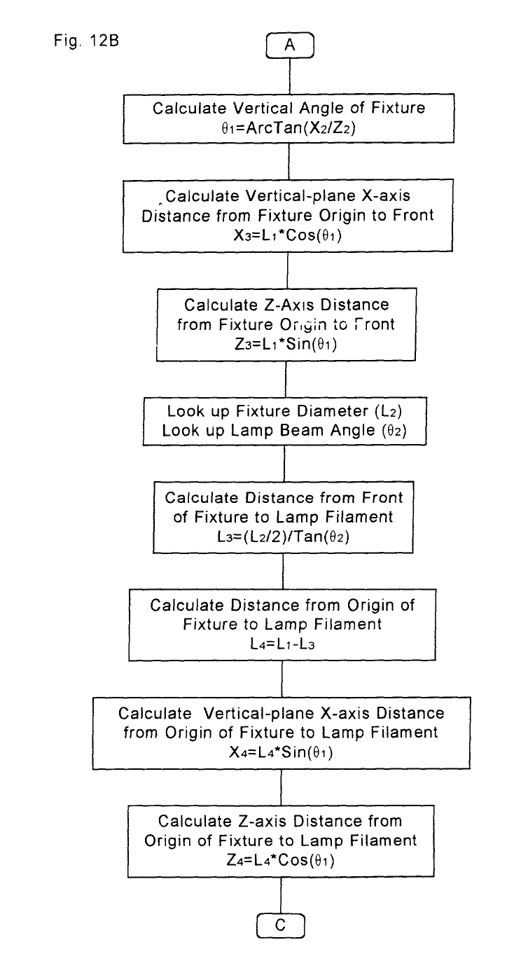

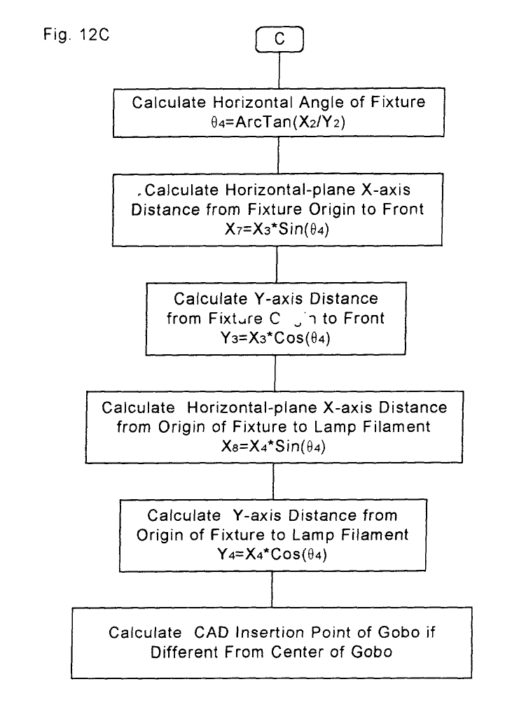

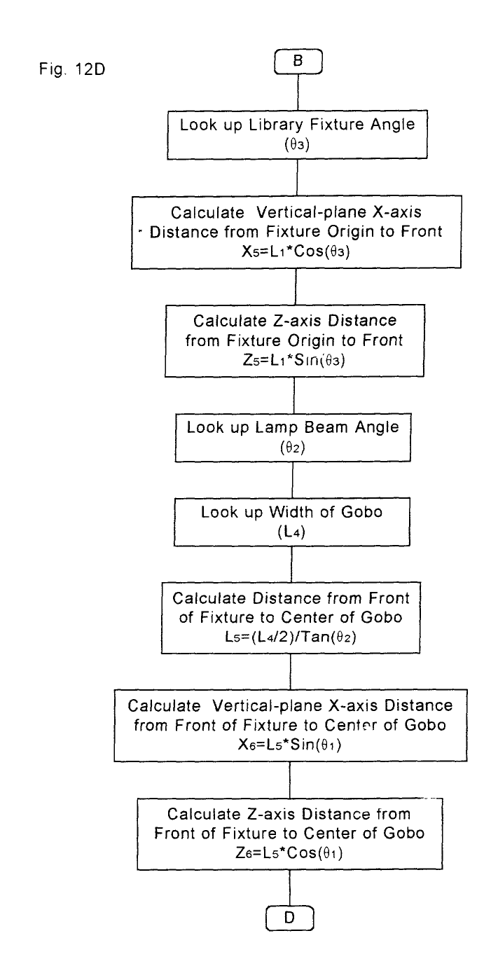

First, as shown in the flowchart in FIG. 12A, the relationship between the lighting instrument 31 and its focus spot 42 are set, either graphically or by entering numbers in a dialog box (FIG. 10). If an omnidirectional light source is used in the drawing, as shown in the flowchart in FIG. 12B, the vertical angle 51 of the lighting instrument 31 is the arctangent of the vertical distance 45 and horizontal distance 44 from the center of the focus spot 42 to the origin 41 of the instrument 31. Next, (See FIG. 4) the horizontal distance 46 of the center point 43 of the front of the instrument is calculated as the distance 48 from the origin 41 to the center point 43 of the instrument times the cosine of the instrument vertical angle 51, and the vertical distance 47 of the center of the front 43 of the instrument is calculated as the distance from the origin 41 to the center of the front 43 of the instrument times the sine of the instrument vertical angle 51.

Once the location of the center of the front of the instrument is known, the distance 49 from the origin 41 to the point source representing the lamp filament 34 can be set in several ways, depending on the tools available in the CAD software being used and the degree of verisimilitude desired in the final rendering. In general, the lamp 32 is modeled as an omnidirectional light source like the sun or as a controlled-angle light source like a PAR (parabolic reflector) lamp, which is available with some CAD software.

If an omnidirectional light source is used, as shown in FIG. 4, the distance 63 from the lamp to front of the instrument is calculated as the radius of the instrument barrel 64 divided by the tangent of the beam angle 53. Any light traveling on a wider angle from the beam center 38 would be intercepted by the instrument body or barrel. Referring to6. 5, the horizontal position 61 of the lamp 32 is the distance 49 from the origin of the instrument to the lamp times the sine of the angle 52, which, by the geometry of reciprocal angles, is the same as the instrument angle 51. The vertical position 62 of the lamp 32 is the distance 49 from the origin of the instrument to the lamp times the cosine of the angle 52.

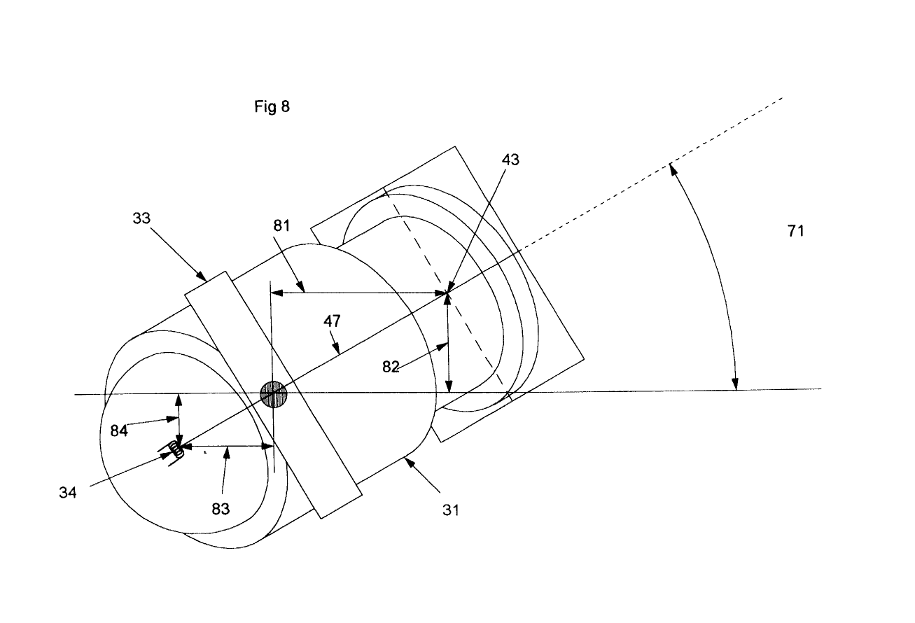

Once the calculations looking sideways are done, a similar set must be performed looking downward (See FIG. 7 and flowchart FIG. 12C). The reference line 70 is usually parallel to the center line of the venue being lit, but other angles could be used if it would be more convenient. The horizontal angle 71 of the instrument 31 from the reference line 70 is the arctangent of the distance 72 perpendicular to the reference line divided by the distance 73 parallel to the reference line of the focus spot 42.

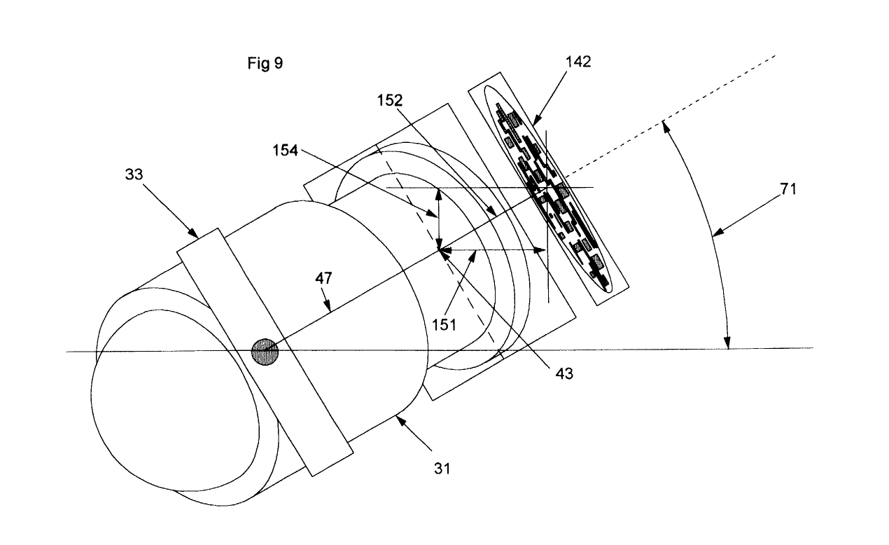

Referring to FIG. 8, the horizontal offset 81 of the center point 43 of the front of the fixture can be calculated as the length 47, which is the horizontal projection of the length 48 from the origin to the center point 43 of the front of the fixture (see FIG. 4) times the cosine of angle 71. The vertical offset 82 of the center point 43 is the length 47 times the sine of angle 71.

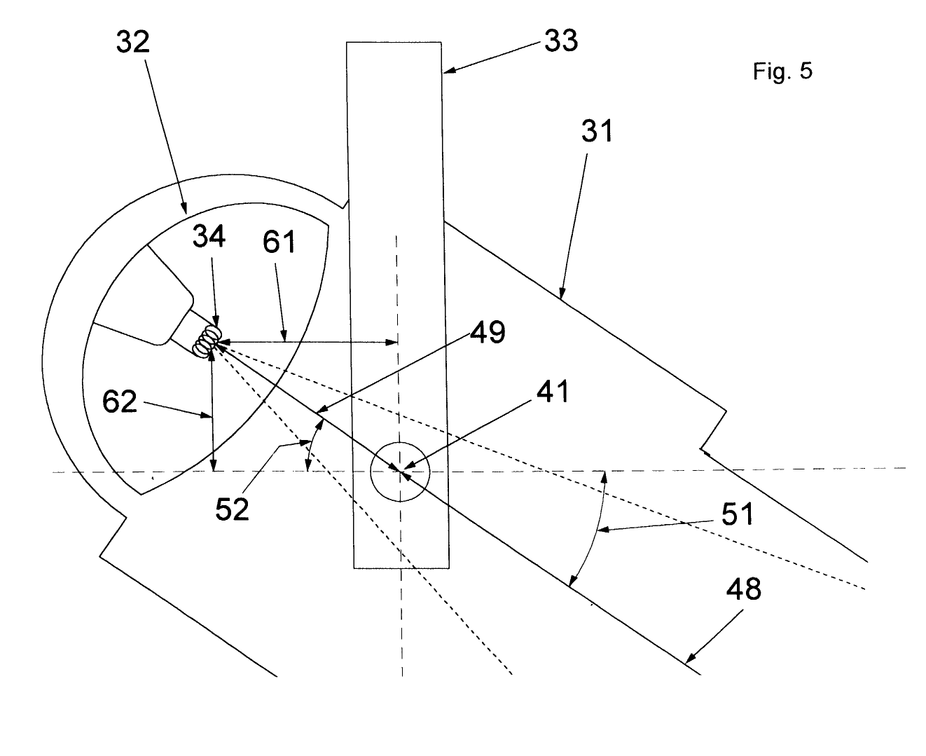

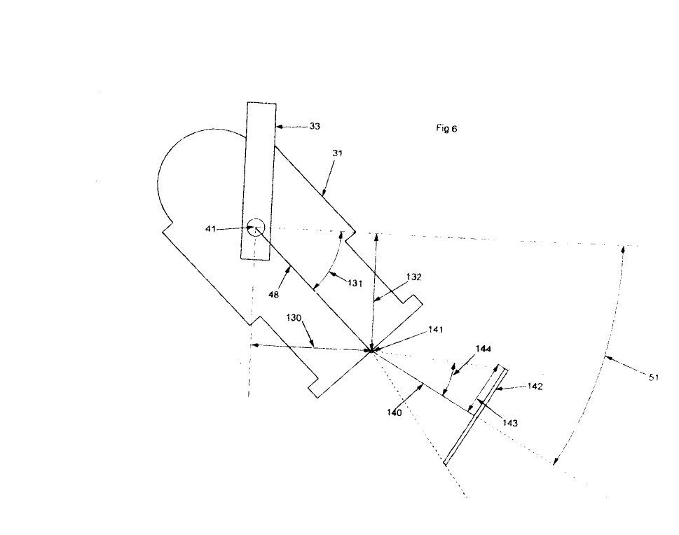

Similarly, the horizontal offset 83 of the lamp filament 34 is the length 61, which is the horizontal projection of the length 61 from the origin to the center point 43 of the front of the fixture (see FIG. 5) times the cosine of angle 71. The vertical offset 84 of the filament 34 is the length 61 times the sine of angle 71.

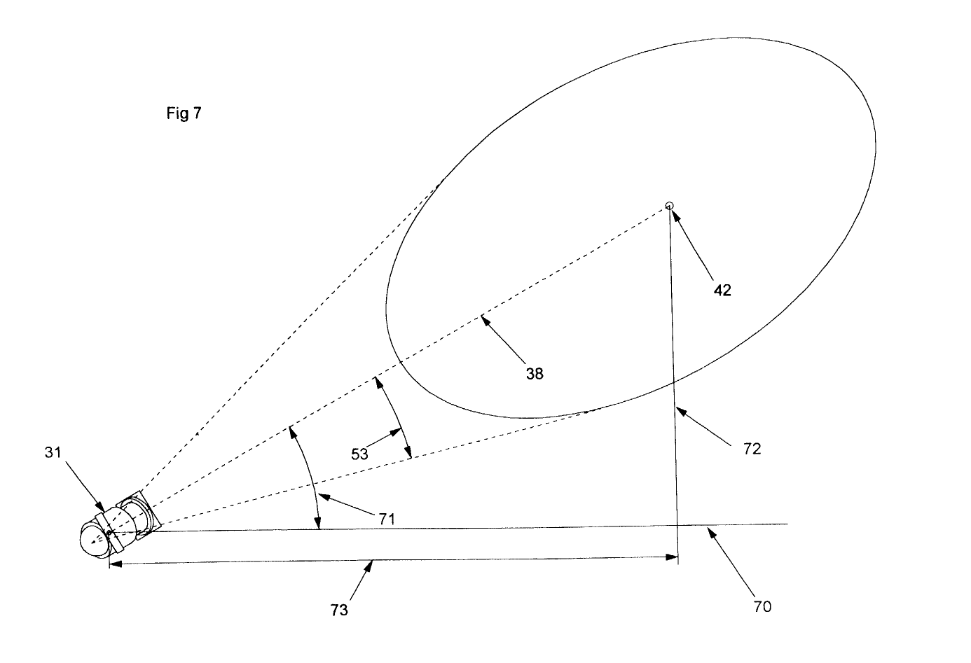

If a controlled-angle light is used, the lamp can be placed in the same manner as an omnidirectional lamp, or at another location, such as the front of the instrument, for convenience, as shown in FIG. 6. This placement is often useful because of the way complex drawing objects, such as lighting instruments, are often handled in CAD programs. Many drawings of generic or particular lighting instruments are available as pre-drawn objects in computer files often called libraries, and, rather than keeping many copies of a complex object in a drawing database (which takes up memory), only the location and the orientation of the object are kept in the drawing database, along with a reference to the object to be placed when the drawing is displayed or printed. In many CAD programs, all instances of a particular object obtained from a library are identical.

If a fixture in a library includes its mounting yoke, changing the angle of a particular fixture in the drawing would also change the angle of the yoke. This would not look proper, so, to keep the mounting yoke in its usual vertical position, so the yoke could be a separate object from the fixture, and placed in the drawing by calculating its position relative to the fixture. Of course, these calculations require time and computer memory, and for most purposes this level of reality is not necessary, so the fixture drawing in the library can have the fixture at a convenient angle, such as 45°from horizontal, with the yoke vertical. All of the instances of this fixture in the drawing will be at the same 45°angle, and a controlled-angle light at the front of the fixture can shine through the gobo which is placed relative to the light, not the fixture. This produces substantially the same effect in a rendered drawing as having the light inside the fixture with the gobo placed at the front of the fixture.

As shown in the flowchart of FIG. 12D, to place a controlled angle lamp 141 at the center of the front of the fixture 31, the horizontal offset 130 of the lamp is the distance 48 from the origin 41 to the front of the fixture times the sine of the standard library fixture angle 131. The vertical offset 132 of the controlled angle lamp 141 is the distance 48 from the origin 41 to the front of the fixture times the cosine of the standard library fixture angle 131.

In order to use the full width of the gobo without having light spill around its edges, the gobo must be placed the proper distance from the lamp. This is the most common way a gobo is used, although settings nearer or farther from the lamp can be used for special effects or to size the pattern for a particular purpose. The standard distance 140 from the lamp 141 to the gobo 142 is the distance 143 from the center of the gobo to its nearest edge divided by the tangent of the lamp beam spread 144. The center of the gobo is placed at the center of the beam from the controlled angle lamp, which is at the angle 51 to the center of the focus spot 42. The gobo is most often placed perpendicular to this angle 51, but other rotations may be used for special effects.

Referring to FIG. 9 and flowchart FIG. 12E, the horizontal offset 151 of the center point of the gobo 142 from the center point 43 of the front of the fixture can be calculated as the length 152, which is the horizontal projection of the length 140 from the origin to the center point 43 of the front of the fixture (see FIG. 6) times the cosine of angle 71. The vertical offset 154 of the center point of the gobo 142 from the center point 43 is the length 152 times the sine of angle 71.

As a result of the foregoing calculations for both omnidirectional and controlled-angle light sources, the center point of the gobo is now known, but, because the gobo is not a point, it may have a different CAD placement point, such as an edge or a corner. The offset from the center of the gobo to the CAD placement point can be calculated from the size and angle of the gobo in a manner similar to that for locating the center point of the gobo in 3-dimensional space.

All of these calculations can be wrapped up into a simple, intuitive tool for the user. In the preferred embodiment, the user merely needs to do is to use an overhead view, such as FIG. 7, select a fixture 31 for focusing, and point to the spot 42 where the center of the beam should hit. The computer looks up the required information about the fixture, lamp and gobo in a database related to the fixture, and then calculates the positions of the light source and gobo so the pattern is projected properly.

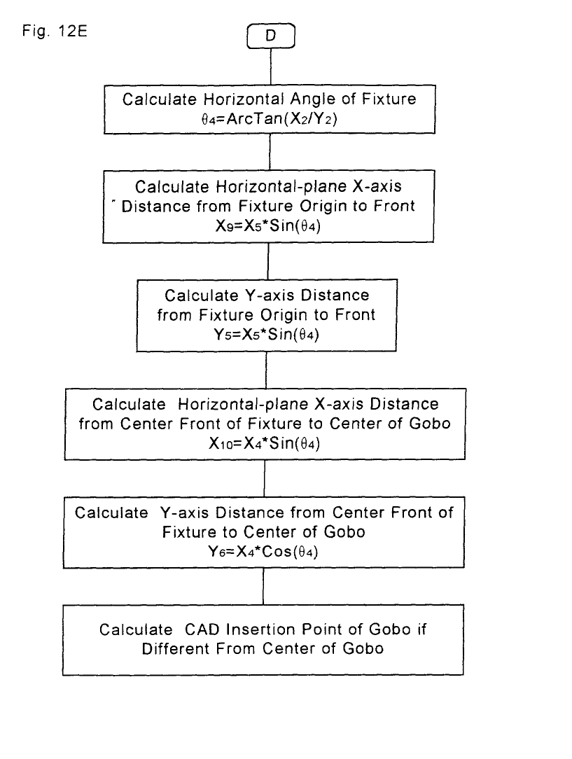

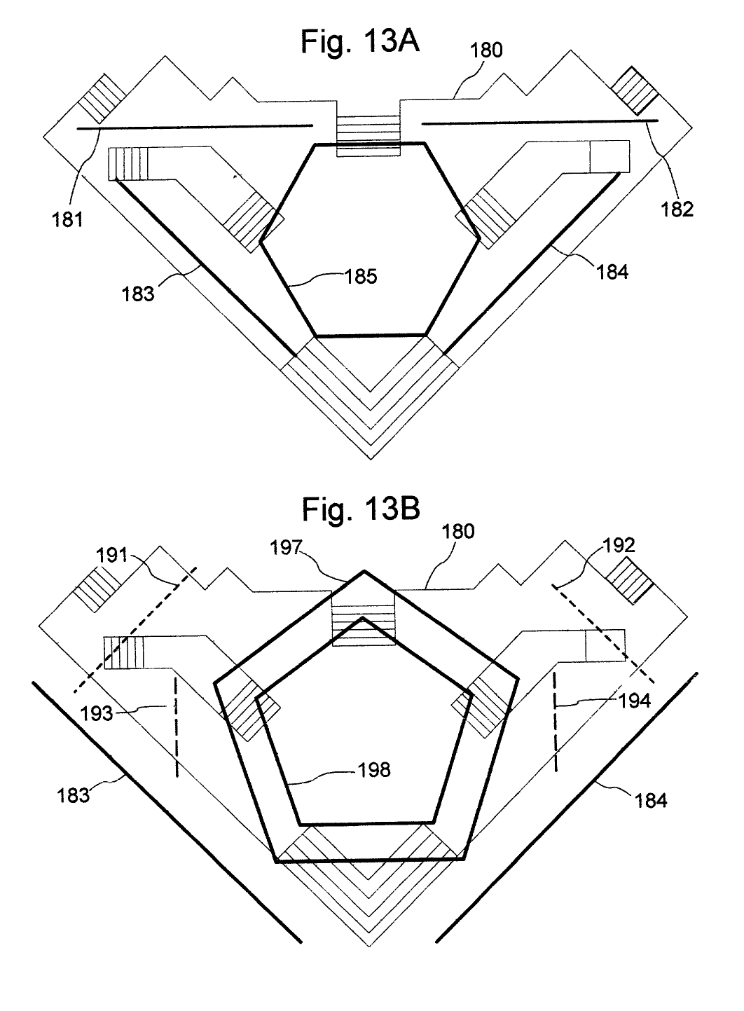

The ability to focus instruments in a lighting system model is beneficial when used with instruments that already exist in a model, but is only a small part in automating the design of complete systems. A stage lighting system most often begins with a drawing of the stage 180, as shown in FIG. 13A, although it can start from an idea for a lighting effect. Auditorium areas are usually included, but are omitted here for clarity, because the same principles and procedures apply.

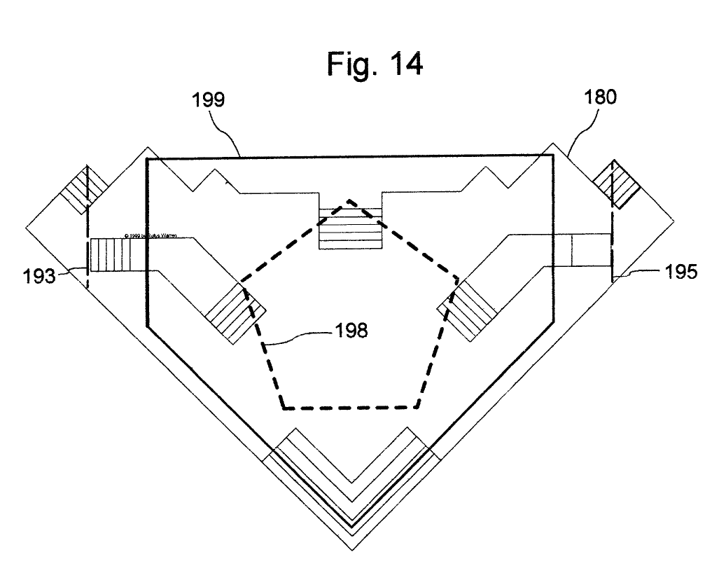

Lines 181, 182, 183, 184 and a shape 185 are placed as shown in FIG. 13A as a first draft outline with placement of pipes, trusses, stands, etc. for supporting and hanging fixtures, speakers and other desired items. As shown in FIG. 13B, lines 183, 184, 191, 192, 193, 194 and shapes 197, 198 can be quickly and easily moved or replaced until the basic idea looks satisfactory to the designer, as shown in FIG. 14.

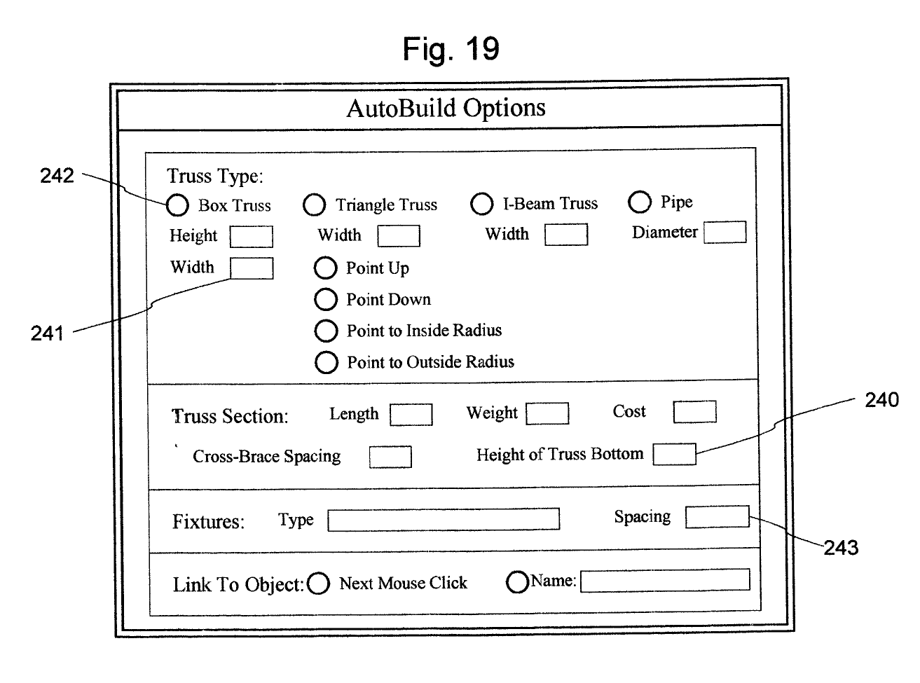

At this point, the user starts the automatic building (“auto-build”) process by selecting one or more of the lines and shapes previously drawn. A dialog box, as shown in FIG. 19, appears to allow the user to set many of the lighting system options. These options include such things as the truss height 240 and cross-section 241, type 242 and spacing of fixtures 243, etc.

This process is fundamentally different from storing objects in libraries for later recall, as is done by many CAD programs. In these other programs, complex objects, such as a 10-foot section of triangular truss with 18-inch sides and six PAR64 fixtures with red filters can be stored as a single symbol. An object identical in all respects except one, like being 7 feet long or using PAR56 fixtures, would be an entirely new object to be drawn and stored. Certainly, CAD programs can keep this modification of existing objects from being too tedious, but every variation which a designer wishes to place as a symbol must be drawn in advance, named, stored, and later found in what can easily become a very large library. If a designer does not want to create and maintain a large library of symbols, he must create or modify objects as he goes, making many detours in the process from inspiration to finished design.

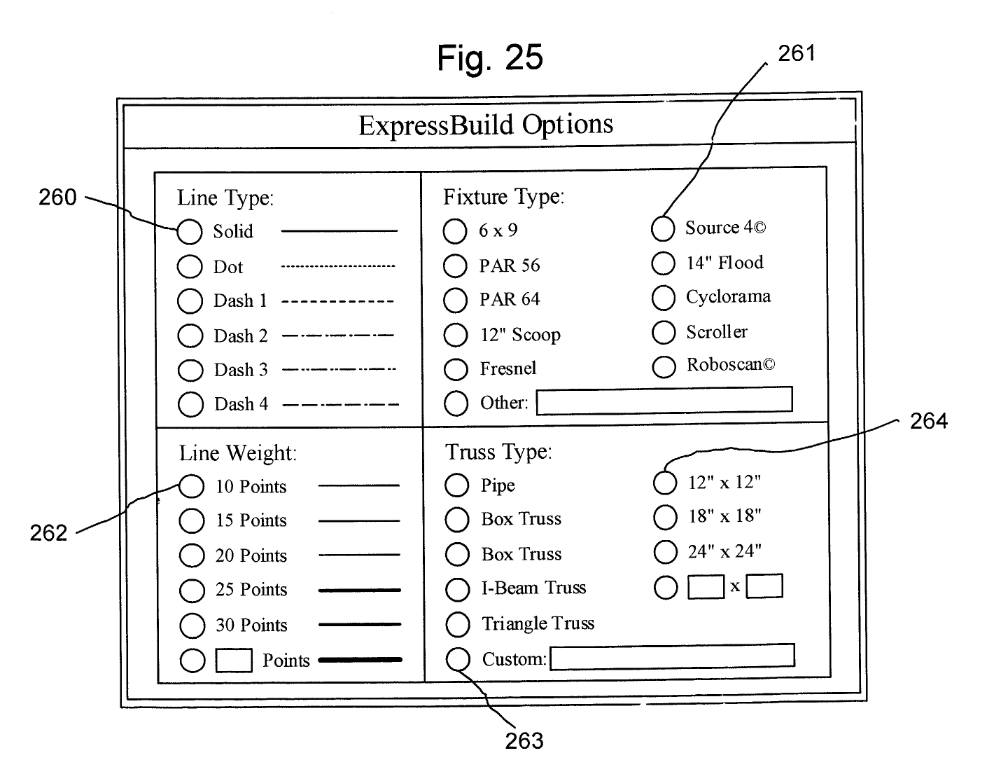

In accordance with the invention, if the user wants an even faster procedure, different kinds of lines can stand for different types of trusses and fixtures. For example, in FIG. 14, thin lines 193, 195 mean pipes and thick lines 198, 199 mean trusses. Similarly, solid lines 199 mean 6×9 ellipsoidals, dotted lines 198 mean PAR64s and dashed lines 193, 195 mean floodlights. Many desired sets of options can be chosen ahead of time, but because there are only a limited number of line thicknesses and styles, not all combinations may be available simultaneously. FIG. 25 shows a dialog box that allows the user to choose which line style 260 stands for which fixture 261, and which line thickness 262 stands for which type of support 263, 264. Because there are hundreds of fixture types available and different users will use various subsets of these fixtures, the choices which are shown in this dialog box can be set as user preferences.

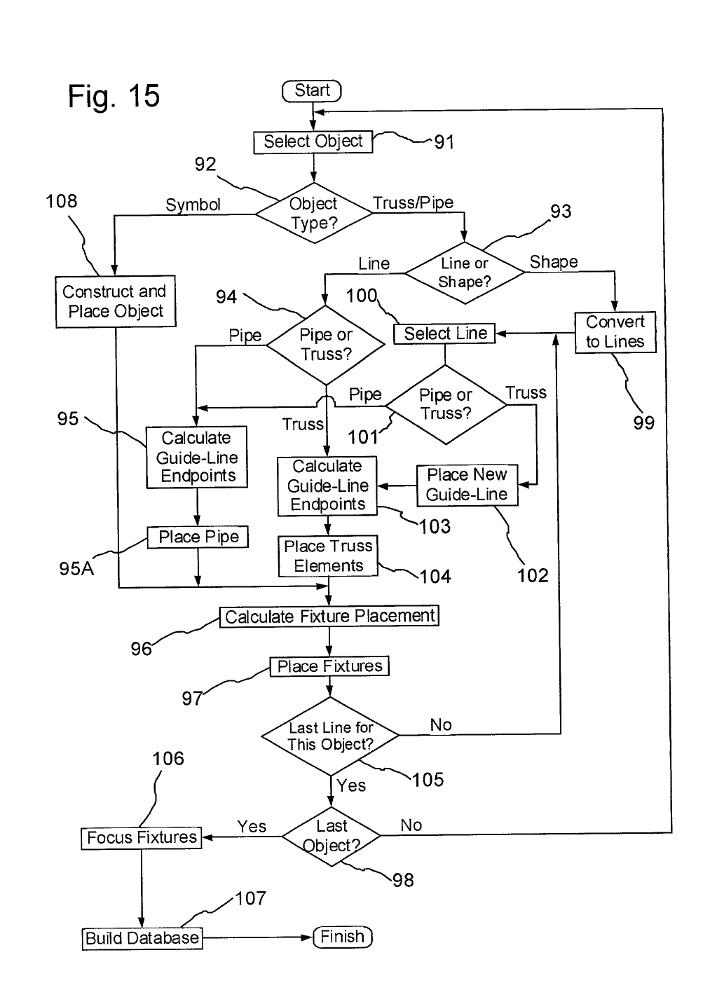

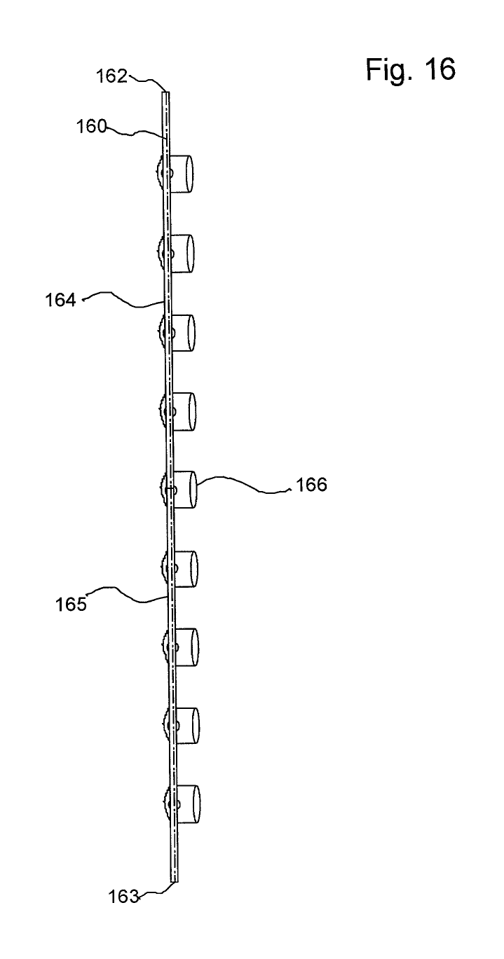

In the AutoBuild process, as shown in FIG. 15 and 16, the first item of the group of drawing objects selected for auto-building is chosen 91 and evaluated 92 for its type. If it is evaluated 93,94 as a single line 160 representing a pipe, the endpoints 162 and 163 of the line are calculated 95 and the centerlines of the pipe sections 164 and 165 are placed 95A on top of the line element. Next, the lighting fixture locations are calculated 96 based on the spacing chosen and the fixtures 166 placed 97 above or below the pipe, as the user chooses. The autobuild process continues 98 with the next object until the rest of the selected lines and shapes are processed.

If, as shown in FIG. 15, the chosen object is evaluated 93, 94 as a single line representing a truss, the endpoints of the line are calculated 95A and the centerlines of the truss sections are placed 95A on top of the line element. The presently disclosed method places the centerline of each truss section on its guide-line. Either side of the truss or any arbitrary offset could be used without changing any basic principle.

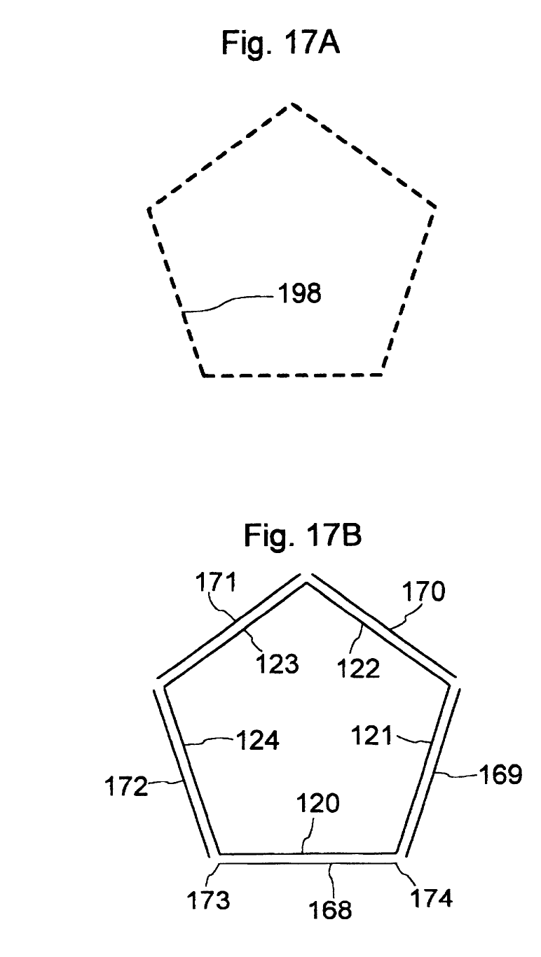

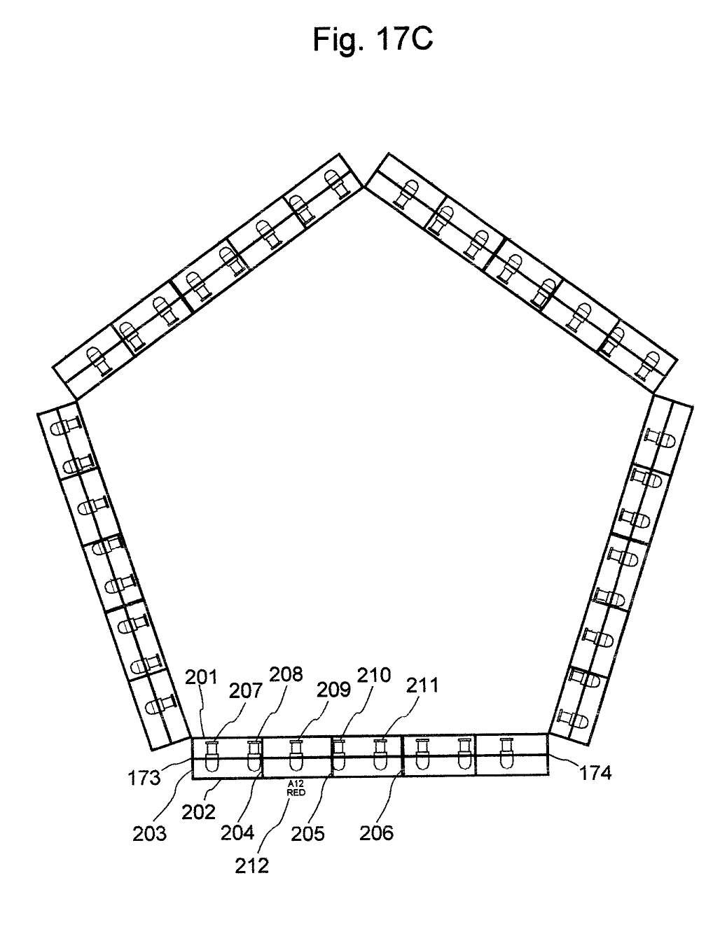

If, as shown in FIGS. 15, 17A and 17B, the chosen object is evaluated 93, 94 as, more than a single line, such as a pentagon 198, it is converted 99 to guide-lines 120, 121, 122, 123, 124, and the lines are processed one at a time 100. If a line represents 101 a pipe, its processing continues as if it were a single line. However, if the line 120 represents 101 a truss, a new guide-line 170 is drawn 102 parallel to the original guide-lines and half the width of the truss away from the center of the shape. This sets the inside edge of the truss section at the original guide-lines so the truss sections based on pentagon 198 do not overlap.

Starting with the first guide-line 120, the endpoints 175, 176 of the guide-line are calculated 103. Next, as shown in FIG. 17C, longitudinal members 201, 202 are placed 104, offset horizontally and vertically as set by user options for the truss cross-section. Then, cross-braces 203, 204, 205, 206, etc. are added, also as set by user options. Lighting fixtures 207, 208, 209, 210, 211, etc. are then placed 97 in relation to the truss, with their offset and spacing set by default or user option. The autobuild process continues 105 with the next truss section until the rest of the lines of the selected shape are processed.

It is, of course, possible to draw a shape that cannot be constructed as a truss. For example, an S-curve with radii of 6 inches cannot be converted into a 24-inch-wide truss. If, as shown in FIG. 15, the chosen object is evaluated 92 as a symbol for a particular structure, such as a lighting tree, the tree is drawn 108 and fitted with fixtures according to the options chosen, and placed on the drawing where its symbol indicates.

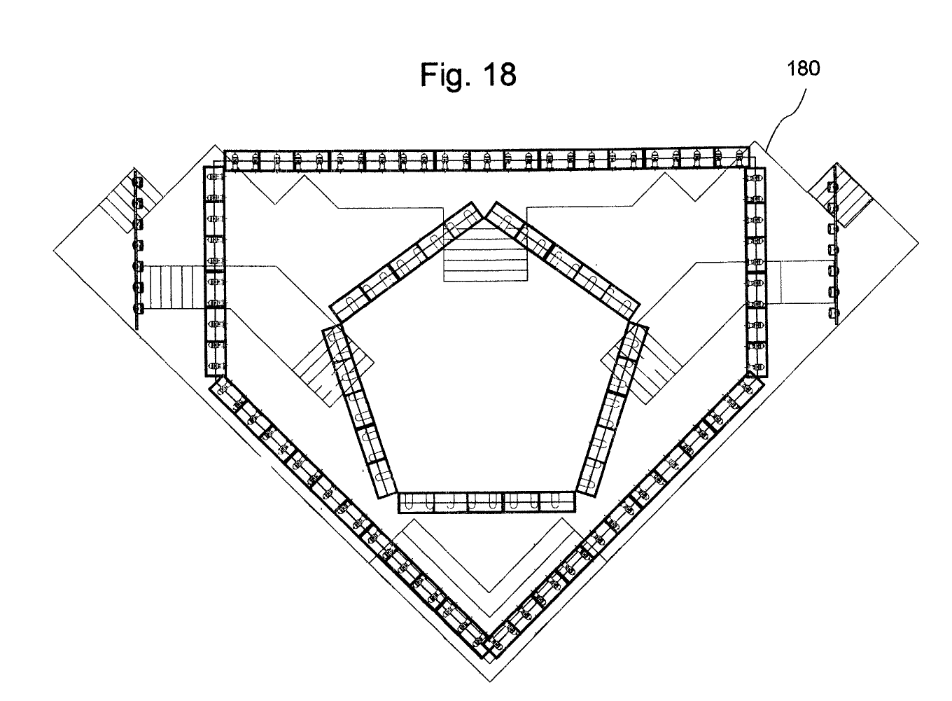

After all of the objects are processed, the fixtures which have been placed are focused 106, and data fields 167 including a unique identifier (such as a fixture number, filter color, etc.) are assigned 107 to each fixture for use in the system database. FIG. 18 shows the completed system that was shown as a draft in FIG. 14.

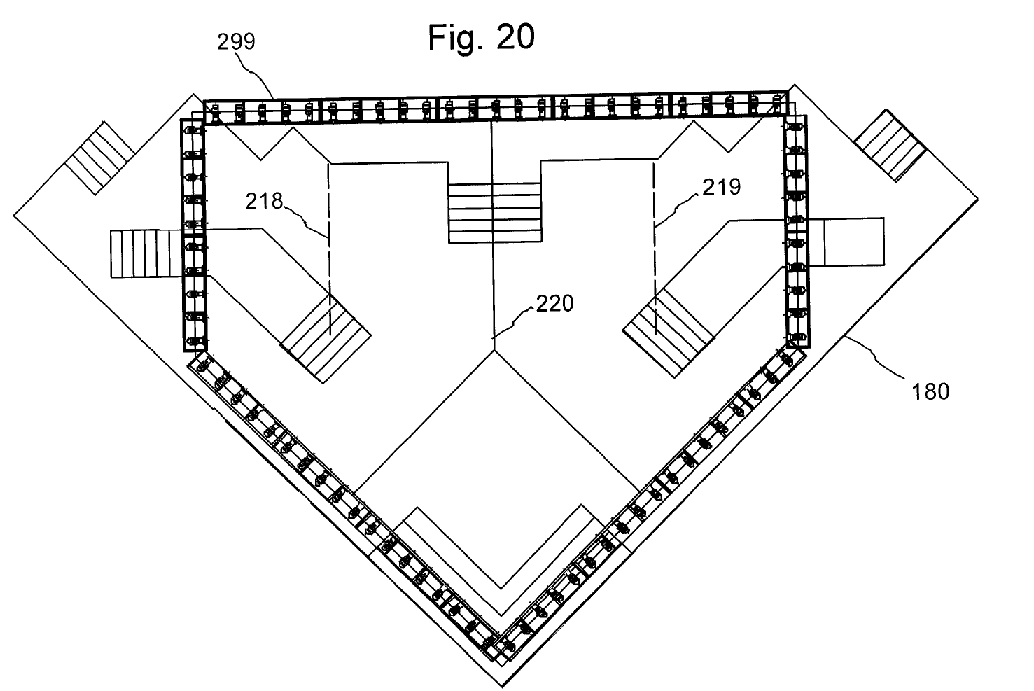

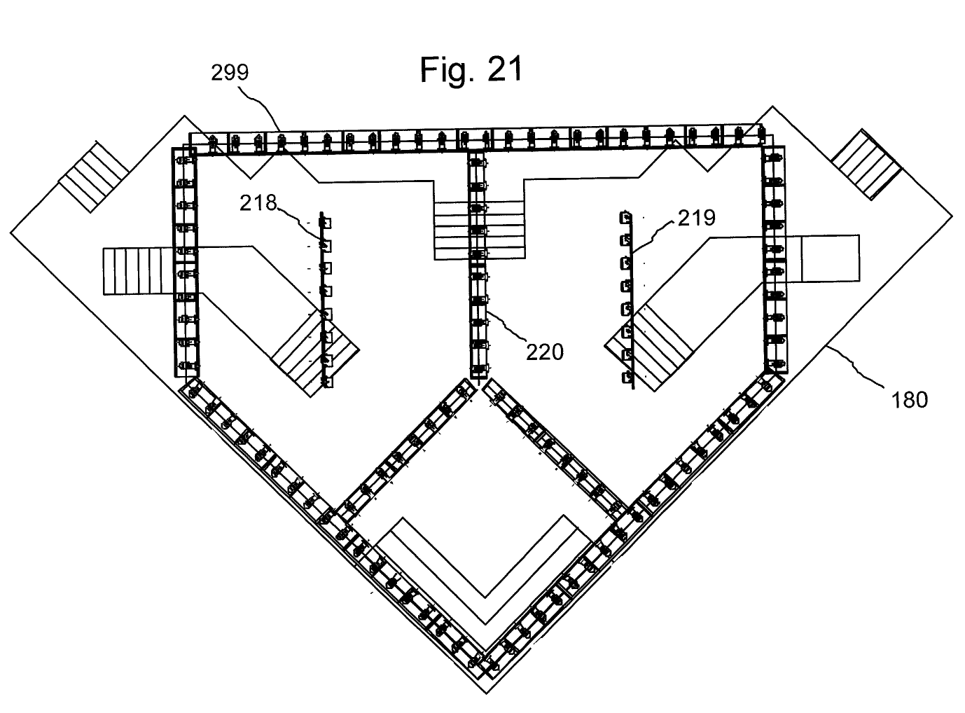

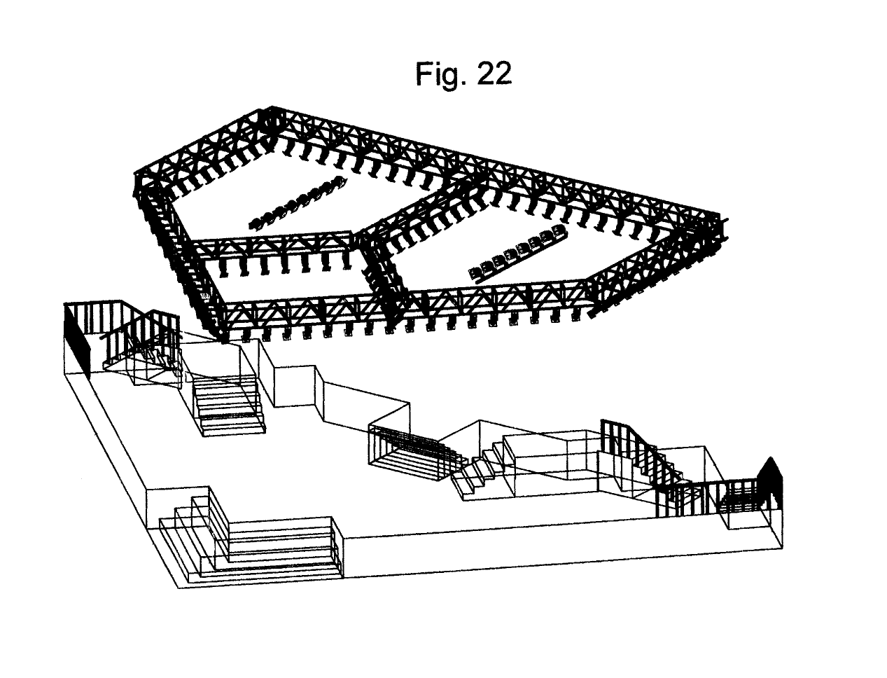

The second major difference from other CAD programs is in design revisions. When an object is drawn it exists where drawn; when chosen from a library, it is placed into the design at the point specified by the designer. In both cases, moving or rotating the object to a new location must be done in what is essentially a series of manual operations: select, move and release. This sequence must be repeated whenever revisions are needed. The present invention makes it so quick to remove or relocate sections, draw or modify base shapes (215, 216, 217 in FIG. 20), and build new sections (218, 219, 220 in FIG. 21) that starting a new auto-built section is usually faster than making changes to an existing section. An orthogonal view, FIG. 22, can be printed or rendered photo-realistically for presentations.

Because of the speed of generating complete systems, many options can be presented to clients, directors, producers, etc. The databases that accompany the drawings make bidding and quoting various artistic choices much faster and more accurate. They also make purchasing the equipment and building the system because there are equipment lists, database fields for channel and dimmer assignment, etc.

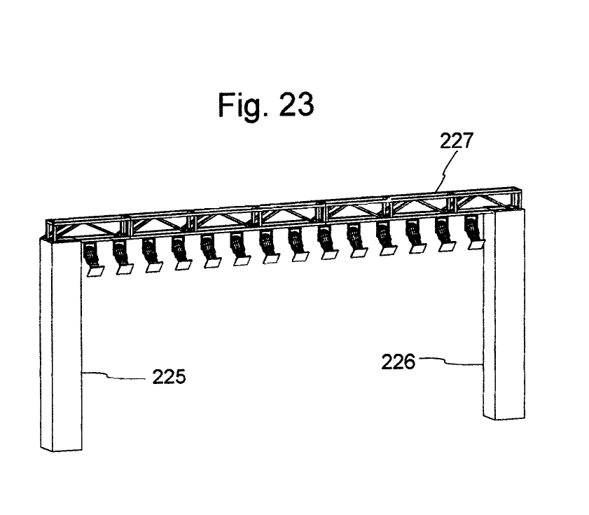

Drawing guide-lines as previously described allows the user to use a sketch-like method to see and modify a lighting system, but this is not the only way to place information into a CAD drawing for an automatic building process. A user can select points or objects in a drawing, and construct straight or curved lines in the memory of the computer without actually drawing the lines, and have a truss or pipe drawn using these virtual lines as guide-lines. Typing into the CAD program can also enter guide-points and fixture information. For example, the user can specify existing or planned support points, such as columns 225, 226 in FIG. 23, for hanging a truss 227, and explore various versions with different fixtures or additional trusses in various arrangements. Another alternative is using information in a spreadsheet or database to specify the system to be auto-built.

Because the program has access to information on the weight and span of each truss section, it can also make rough estimates of the number of supports or hoists that will be needed for the system. Of course this estimate should be reviewed by a person with the appropriate engineering knowledge to make certain that no unsafe conditions could occur, but the rough estimate would make preliminary quotes much faster than manual estimates.

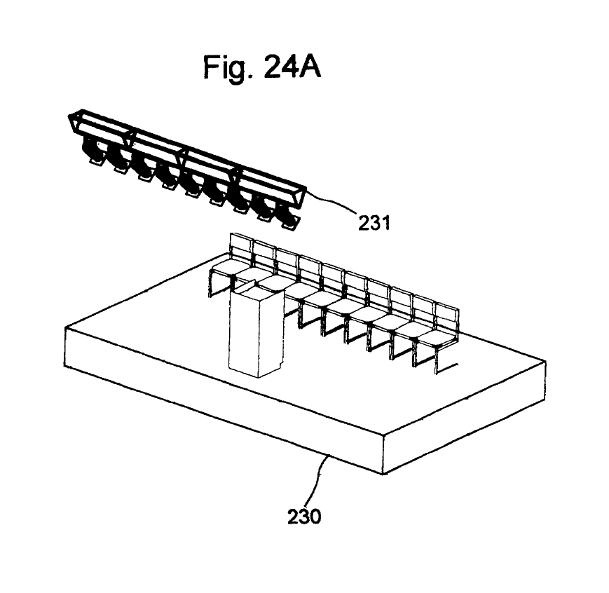

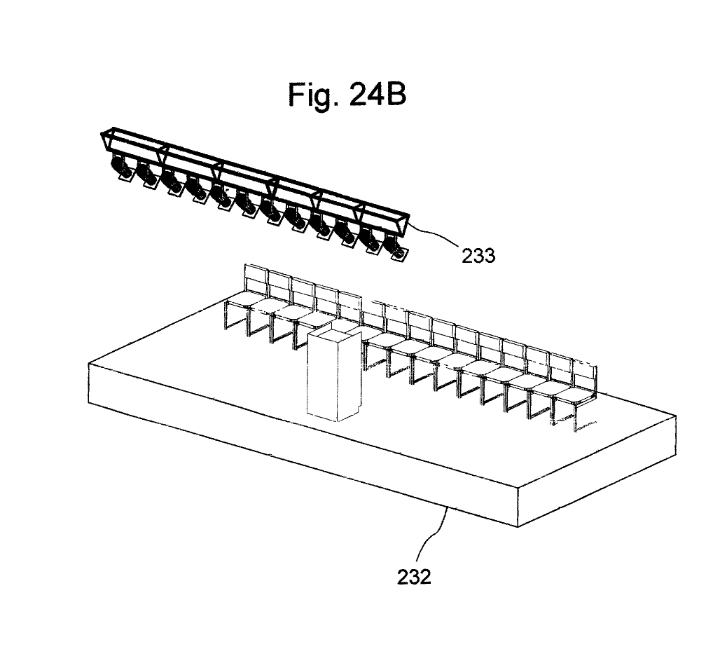

The size of an object used as a guide can be employed to change the size of auto-built objects. As shown in FIGS. 24A and 24B, the width of podium 230 (FIG. 24A) has been enlarged 232 (FIG. 24B) to hold more people, and therefore the length of the lighting truss 231 (FIG. 24A) is increased 233 (FIG. 24B) to maintain consistent illumination levels for the podium. This allows for a quick estimate of the impact of construction changes on lighting system cost, power, weight, etc. The user selects the items to be auto-built, the guide-object, and the parameter of the guide-object to use in scaling the auto-built items.

The usefulness of the present invention is not limited to stage lighting systems. Plumbing and ventilation are two fields where a quick sketch of a few lines can be auto-built into complete three-dimensional views for presentations and bids rather than manual estimates or CAD drawings requiring the repetitious manual placement of elements. Urban and subdivision planners can sketch street layouts quickly using guide-lines to represent streets, with user options for traffic lanes, sidewalks and the types and mix of buildings.

The user can also specify an offset from one or more guide-points as the guide-point to be used in the auto-building process. For example, an object such as a lectern may be chosen and a truss placed so the angle of the truss is always 45 degrees from vertical wherever the lectern is placed or moved

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

What is claimed is:

1. A method for modeling the utilization of substantially all of an emitted beam of a lamp in a lighting fixture by a gobo which is not necessarily the same diameter as a barrel of the fixture, said method comprising:
computing a placement of a point source of light inside said lighting fixture to yield a specified beam angle; and
computing a placement of said gobo in front of said lighting fixture so the diameter of said gobo matches the diameter of said emitted beam emerging from said fixture.

2. A method for modeling a lighting system, said method employing a computing system having graphic a display, said method comprising:
entering and storing lighting fixture data into said computing system;
entering and storing fixture support data into said computing system;
entering and storing guide data into said computing system, said guide data including the types and locations of fixture supports and lighting fixtures;
computing from said guide data a two or three dimensional representation of said lighting system; and
displaying said representation on said graphic display.

3. A method for automatically constructing a relatively complex representation of an object based on a relatively simple representation of an object, comprising:
generating a relatively simple representation of an object; and
building a link between said relatively simple shape representation and a relatively complex representation of an object stored in a library.

4. The method of claim 3 wherein said building comprises opening a dialog box and completing information in said dialog box identifying a link between said relatively simple representation of an object and said relatively complex representation of an object.

5. The method of claim 3 and further including repeating the steps of generating a relatively simple representation of an object and building a link an additional one or more times.

6. The method of claim 3 and further including storing said link.

7. The method of claim 4 and further including storing each of said links.

8. The method of claim 3 and further including recalling said link.

9. The method of claim 5 and further including recalling one or more of said links.

10. A system for modeling the utilization of substantially all of an emitted beam of a lamp in a lighting fixture by a gobo which is not necessarily the same diameter as a barrel of the fixture, said system comprising:
means for computing a placement of a point source of light inside said lighting fixture to yield a specified beam angle; and
means for computing a placement of said gobo in front of said lighting fixture so the diameter of said gobo matches the diameter of said emitted beam emerging from said fixture.

11. A system for modeling a lighting system, employing a computing system having a graphic display, said system comprising:
means for entering and storing lighting fixture data into said computing system;
means for entering and storing fixture support data into said computing system;
means for entering and storing guide data into said computing system, said guide data including the types and locations of fixture supports and lighting fixtures;
means for computing from said guide data a two or three dimensional representation of said lighting system; and
means for displaying said representation on said graphic display.

12. A system for automatically constructing a relatively complex representation of an object based on a relatively simple representation of an object, comprising:
means for generating a relatively simple representation of an object; and
means for building a link between said relatively simple representation and a relatively complex representation of an object stored in a library.

13. The system of claim 12 wherein said means for building comprises means for opening a dialog box and means for completing information in said dialog box identifying a link between said relatively simple representation of an object and said relatively complex representation of an object.

14. The system of claim 13 and further including means for storing said link.

15. The system of claim 13 and further including means for recalling said link.

16. A method for automatically constructing arrays of complex shapes based on simple shapes, said method employing a computing system having graphic display means, data entry means, data processing means and a memory, said method comprising the steps of:
entering and storing said complex shapes into said computing system;
entering and storing shape translation data into said computing system;
entering and storing said simple shapes into said computing system;
computing said arrays of complex shapes based on the parameters of said simple shapes; and
displaying said arrays of complex shapes on said monitor.
